(19) United States
(12) Patent Application Publication
(10) Pub. No.: US 2023/0333382 A1
(43) Pub. Date: Oct. 19, 2023

(54) OPTICAL ASSEMBLY FOR A HEAD-MOUNT DISPLAY (HMD) DEVICE

(71) Applicant: Meta Platforms Technologies, LLC, Menlo Park, CA (US)

(72) Inventors: Zhisheng YUN, Sammamish, WA (US); Pavel TROCHTCHANOVITCH, Redmond, CA (US); Fei LIU, Los Altos, CA (US)

(73) Assignee: Meta Platforms Technologies, LLC, Menlo Park, CA (US)

(21) Appl. No.: 17/988,638

(22) Filed: Nov. 16, 2022

Related U.S. Application Data
(60) Provisional application No. 63/330,411, filed on Apr. 13, 2022.

(51) Int. Cl. G02B 27/01; G02B 30/10

(52) U.S. Cl. CPC G02B 27/0172; G02B 30/10; G02B 2027/011; G02B 2027/0123; G02B 2027/0134

(57) ABSTRACT

According to examples, an optical assembly for a head-mounted display (HMD) device may include a compensation element to modify a phase of a first light arriving from an environment outside the head-mounted display (HMD) device; a transparent display to present an image or a video and to pass through the phase-modified first light; and a focus element to focus the phase-modified first light and a second light from the transparent display on an eyebox. The optical assembly may reduce one or more aberrations in the first light or the second light. The focus element may be a metalens, a light field lens, a solid optical lens, or an optical configuration with two optical elements including an air gap between the two optical elements. The compensation element may be a free-form phase plate.

### CROSS REFERENCE TO RELATED APPLICATIONS

This patent application claims the benefit of U.S. Provisional Patent Application Ser. No. 63/330,411 filed on Apr. 13, 2022. The disclosures of the above application are hereby incorporated by reference for all purposes.

### TECHNICAL FIELD

This patent application relates generally to compact and low-profile display systems, and more specifically, to a head-mount display (HMD) device using an optical assembly including a focus element, a transparent display, and a compensation element.

### BACKGROUND

A head-mounted display (HMD) may be a headset or eyewear used for video playback, gaming, or sports, and in a number of contexts and applications, such as virtual reality (VR), augmented reality (AR), and/or mixed reality (MR). A head-mounted display (HMD) device may communicate information to or from a user who is wearing the headset. For example, a virtual reality (VR) headset may be used to present visual information to simulate any number of virtual environments when worn by a user. That same virtual reality (VR) headset may also receive information from the user's eye movements, head/body shifts, voice, or other user-provided signals.

A conventional head-mounted display (HMD) device, however, relies on optical configurations that are typically large and bulky. As head-mounted displays (HMDs) are generally worn on users' heads for prolonged periods, it is becoming more important to emphasize and improve upon head-mounted display (HMD) device characteristics, such as compactness, weight, and optical performance, especially in design and implementation. However, improving optical performance may typically involve increasing the number or size of optical components, which in turn may create or add more bulk and weight. Other head-mounted displays (HMDs) may have optical configurations that improve compactness and reduce size and weight, but these conventional display devices, having fewer optical components, may often have decreased optical resolution or visual acuity, such as limitations with central and/or peripheral fields of view (FOVs) for the user.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a head-mounted display (HMD) device 100, according to an example.

FIG. 2 illustrates a cross section view of simplified version of a head-mounted display (HMD) device 200, according to an example.

FIG. 3 illustrates an optical assembly of a head-mount display (HMD) device with a focus element, a transparent display, and a compensation element, according to an example.

FIG. 4 illustrates a number of implementations of the optical element, according to an example.

FIG. 5 illustrates focusing of visual content from a display to an eyebox through an optical lens configuration, where the display is smaller than the optical lens configuration, according to an example.

FIG. 6 illustrates focusing of visual content from a display to an eyebox through an optical lens configuration, where the display is larger than the optical lens configuration, according to an example.

FIG. 7 illustrates a number of optical lens configurations for the focus element, according to an example.

FIG. 8 illustrates details of an optical lens configuration for the focus element with a reflective polarizer layer, a quarter wave layer, and a semi-transparent mirror, according to an example.

FIGS. 9A-9E illustrate a number of configurations of reflective polarizer layer, quarter wave layer, and semi-transparent mirror in an optical lens configuration for the focus element, according to an example.

FIG. 10A illustrates an assembly system to provide a head-mount display (HMD) device with an optical lens configuration, according to an example.

FIG. 10B illustrates an assembly system to provide a head-mount display (HMD) device with an optical assembly including a focus element, a transparent display, and a compensation element, according to an example.

FIG. 11A illustrates a flowchart 1100A of a method to assemble a head-mount display (HMD) device with an optical lens configuration, according to an example.

FIG. 11B illustrates a flowchart 1100B of a method to assemble a head-mount display (HMD) device with an optical assembly including a focus element, a transparent display, and a compensation element, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

As discussed herein, head-mounted displays (HMDs) may include optical configurations that are typically large and bulky, and therefore, may be vulnerable to compactness, weight, and optical performance issues. For example, Simple lenses may be prone to aberrations, especially chromatic aberration, and therefore, may not be suitable for precise imaging. Doublets, which are made up of two simple lenses paired together may allow more optical surfaces, thicknesses, and formulations, and thus, provide additional degrees of freedom to correct more optical aberrations and improve image precision. Conventional doublets, which may include oil or similar materials in a gap between the two lenses, may add to weight challenges in a head-mounted display (HMD) device, especially when larger size lenses may be needed to focus display content on an eyebox.

Furthermore, augmented reality (AR) and/or mixed reality (MR) head-mounted display (HMD) devices may combine a view of a user's environment, that is light from the environment, with displayed content (light from the display). While the light from the environment may be unpolarized, the light from the display is likely to be polarized. Thus, the different lights may be subject to different aberrations when they pass through the optical elements such as lenses in order to be focused on an eyebox.

Disclosed herein are systems, apparatuses, and methods that may provide a head-mount display (HMD) device using an optical assembly of a focus element, a transparent display, and a compensation element. In some examples, the focus element, the transparent display, and the compensation element may be arranged such that light from the environment may pass through the compensation element, the transparent display, and focused on the eyebox through the focus element. Light from the transparent display may also be focused on the eyebox through the focus element.

In some examples, the compensation element may modify a phase profile of incident light from the environment and/or correct spherical and/or coma aberrations before the light from the environment passes through the transparent display. The focus element may be implemented in a number of different ways and may correct chromatic aberrations in addition to focusing the light from the environment and the light from the display to the eyebox. For example, the focus element may be implemented as a metalens, in which phase may be induced by nanostructures on a substrate, thereby acting as a diffractive optical lens without the chromatic aberrations. The focus element may also be implemented as a light field lens, which may generate 3D data from a 2D image. In other examples, the focus element may be implemented as an optical lens configuration (also referred to as hollow singlet optical lens configuration), where selected surfaces of two optical elements with a gap between them may be provided with a reflective polarizer layer, a quarter wave layer, and/or a semi-transparent mirror to reduce chromatic aberration while focusing the lights on the eyebox.

In some examples, an optical lens configuration may include two optical elements having a gap in between these two optical elements. In some examples, surfaces of the individual elements may also be provided with any number of optical layers. These may include, but not limited to, a reflective polarizer layer, a quarter wave layer, a semi-transparent mirror, or other optical layer. These optical layers may be used by the optical lens configuration, for example, to help focus visual content on a display of the head-mount display (HMD) system to an eyebox.

In some examples, the optical lens configuration may generate optical power through by reflecting surfaces of the cavity between the elements. The two-element optical lens configuration may provide non-chromatic aberration resulting in improved optical imaging quality and increased compactness. Two more refractive surfaces may reduce spherical aberration, coma, astigmatism, and/or field curvature. Furthermore, the optical lens configuration may allow reduced weight for the optical components of the head-mount display (HMD) device. The optical lens configuration may also allow simpler, higher yield production compared to conventional lens systems. Other benefits and advantages may also be apparent.

An optical assembly as used herein refers to a collection of optical components for a head-mount display (HMD) device that include a focus element, a transparent display, and a compensation element for focusing light from the environment as well as light from the transparent display onto an eyebox while mitigating aberrations. An optical configuration as used herein refers to two optical elements having a gap in between these two optical elements. In some examples, the optical configuration may be used as a focus element among other implementations. An optical element as used herein refers to an optical lens that may form together with another optical lens an optical configuration for example. In other examples, a single optical element (an optical lens) may also be used as the focus element.

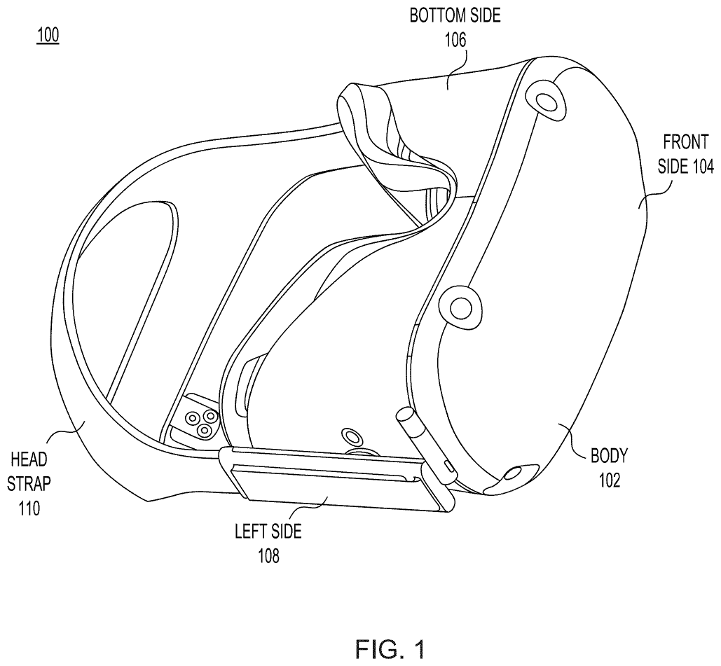

FIG. 1 illustrates a head-mounted display (HMD) device 100, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements, and may include use of technologies associated with virtual reality (VR), augmented reality (AR), and/or mixed reality (MR). As used herein a “user” may refer to a user or wearer of a “near-eye display.”

Head-mounted display (HMD) device 100 shown in FIG. 1 in the perspective view includes a body 102, a front side 104, a bottom side 106, a left side 108, and a head strap 110. In some examples, the head-mounted display (HMD) device 100 may be a part of a virtual reality (VR) system, an augmented reality (AR) system, a mixed reality (MR) system, another system that uses displays or wearables, or any combination thereof. In some examples, the head strap 110 may have an adjustable or extendible length. In particular, in some examples, there may be a sufficient space between the body 102 and the head strap 110 of the head-mounted display (HMD) device 100 for allowing a user to mount the head-mounted display (HMD) device 100 onto the user's head. In some examples, the head-mounted display (HMD) device 100 may include additional, fewer, and/or different components.

In some examples, the head-mounted display (HMD) device 100 may present to a user, media or other digital content including virtual and/or augmented views of a physical, real-world environment with computer-generated elements. Examples of the media or digital content presented by the head-mounted display (HMD) device 100 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 1) enclosed in the body 102 of the head-mounted display (HMD) device 100.

In some examples, where the head-mounted display (HMD) device 100 may provide solely virtual reality (VR) applications, the front side 104 of the body 102 may be opaque as see-through functionality may not be needed for such applications. On the other hand, head-mounted displays (HMDs) providing augmented reality (AR) and/or mixed reality (MR) applications may include a transparent front side 104 to allow the user to see through to the real environment, which may be augmented with artificial content by the respective application. Thus, in any scenario, display optics (i.e., one or more lenses) may be used to focus content from a display in the body 102 and/or the environment to an eyebox.

In some instances, fora head-mounted display (HMD) device (also referred to as “near-eye display system”), it may generally be desirable to expand an eyebox, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular HMD) or both eyes (for binocular HMDs). Also, as used herein, an “eyebox” may be a two-dimensional box that may be positioned in front of the user's eye from which a displayed image from an image source may be viewed.

In some examples, the display electronics of the head-mounted display (HMD) device 100 may display or facilitate the display of images to the user according to data received from, for example, a communicatively coupled console or server (not shown in FIG. 1). In some examples, the display electronics may include one or more display panels. In some examples, the display electronics may include any number of pixels to emit light of a predominant color such as red, green, blue, white, or yellow. In some examples, the display electronics may display a three-dimensional (3D) image, e.g., using stereoscopic effects produced by two-dimensional panels, to create a subjective perception of image depth.

In some examples, the display optics may display image content optically (e.g., using optical waveguides and/or couplers) or magnify image light received from the display electronics, correct optical errors associated with the image light, and/or present the corrected image light to a user of the head-mounted display (HMD) device 100. In some examples, the display optics may include a single optical element or any number of combinations of various optical elements as well as mechanical couplings to maintain relative spacing and orientation of the optical elements in the combination. In some examples, one or more optical elements in the display optics may have an optical coating, such as an anti-reflective coating, a reflective coating, a filtering coating, and/or a combination of different optical coatings.

In some examples, the display optics may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

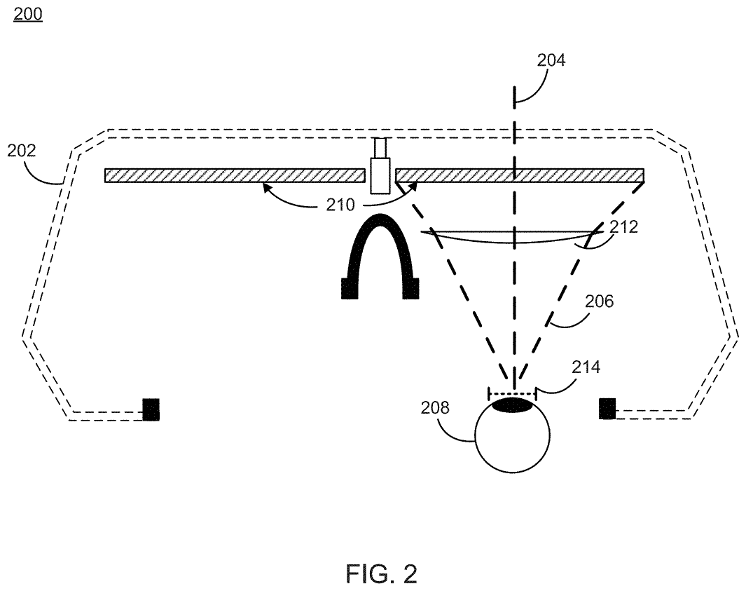

FIG. 2 illustrates a cross section view of simplified version of a head-mounted display (HMD) device 200, according to an example. The head-mounted display (HMD) device 200 shown in FIG. 2 with select components for illustration purposes may include a rigid body 202 housing various electronic and optical components, display(s) 210, and optical lens configuration 212. An eye 208 and associated eyebox 214, along with primary optical axis 204 and optical axis 206 are also shown.

In some examples, virtual reality (VR), augmented reality (AR), and/or mixed reality (MR) content may be displayed through display(s) 210 within the head-mounted display (HMD) device 200. The display(s) 210 may be transparent or semi-transparent to allow the user (i.e., the eye 208) to see the environment through the transparent or semi-transparent body 202 of the head-mounted display (HMD) device 200.

In some examples, the optical lens configuration 212 may provide a larger or expanded field of view (FOV) to improve a user's immersive experience. In some examples, the head-mounted display (HMD) device 200, as shown, may include a primary optical axis 204 and an optical axis 206. To a user's eye 208, the primary optical axis 204 may provide a central field of view (FOV) and the tiled optical axis 206 may provide a peripheral field of view (FOV).

In some examples, the content displayed on the display(s) 210 may be focused on the eyebox 214 by the optical lens configuration 212. As shown in the figure, the optical lens configuration 212 may practically expand the optical axis 206 between the optical lens configuration 212 and the display(s) 210 allowing a wider area of content to be focused on the eyebox 214. Single lenses, if used as optical lens configuration 212 may cause chromatic aberration, as discussed previously. An optical lens configuration comprising two lenses with an air gap between them, according to some examples, may, on the other hand, reduce spherical aberration, coma, astigmatism, and/or field curvature by providing additional refractive surfaces. Additionally, the combination of two light-weight lenses in a single structure may allow thinner lenses to be used reducing overall weight of the head-mount display (HMD) device 200.

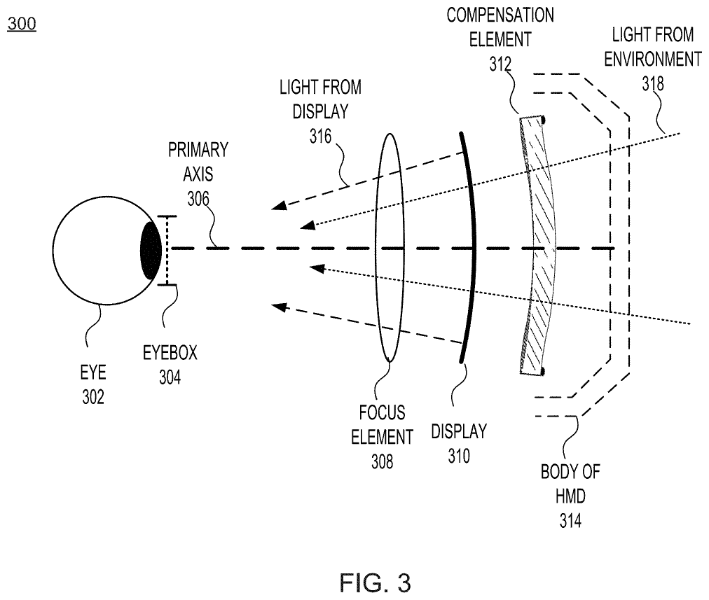

FIG. 3 illustrates an optical assembly of a head-mount display (HMD) device with a focus element, a transparent display, and a compensation element, according to an example. Diagram 300 shows light from the environment 318 passing through a transparent or semi-transparent front side of a body 314 of a head-mounted display (HMD) device, a compensation element 312, and a display 310 before being focused on an eyebox 304 by a focus element 308 for viewing by eye 302 of a user. Light from the display 316 may originate at the display 310 and be focused by the focus element 308 on the eyebox 304. The eyebox 304, the focus element 308, the display 310, and the compensation element 312 may be centrally aligned around a primary axis 306. In some examples, the compensation element 312 may have a substantially similar optical focus power as that of the focus element 308, but with a reverse sign to compensate the focus power from the focus element 308 such that the user may see his/her environment without any focus power. In other examples, the compensation element 312 may have a different focus power compared to that of the focus element 308 to correct one or more of a myopia, a hyperopia, or an astigmatism.

In some examples, head-mounted display (HMD) devices providing augmented reality (AR) and/or mixed reality (MR) applications may include a transparent front side of a body 314 to allow the user to see through to the real environment, which may be augmented with artificial content by the respective application.

In some examples, the compensation element 312, to compensate a focus power introduced by the focus element 308, may be a free-form phase plate, a zoom focus lens, a liquid lens, or similar phase correction structure to modify the phase profile of light passing through. For example, wavefront deformations may be compensated in form of spherical or coma aberrations. Depending on a particular aberration correction, the compensation element 312 may have a radially symmetric or a pseudo-random phase change profile.

In some examples, the compensation element 312 (free-form phase plate) may operate based on having one or both surfaces of the plate a tailored surface relief, thus, a spatially variable path length through the plate material (e.g., an optical glass). As a refractive index of the plate material may be substantially higher than that of air, even small surface features may lead to substantial phase changes. Alternatively, the compensation element 312 may operate based on a variation of the refractive index in the medium, while having flat (and typically parallel) surfaces. In some examples, anti-reflection coatings may be applied to both surfaces of a phase corrector structure in order to minimize reflection losses and potentially disturbing effects of parasitic reflected beams.

In some examples, the compensation element 312 may be fabricated through a number of techniques including, but not limited to, cylindrical coordinate machining such as diamond turning, etching, photolithography, grinding, and raster flycutting. In case of compensation elements with refractive index variations within the material, holography techniques may be applied, for example, to automatically obtain a phase profile for compensating optical aberrations of certain optical elements.

In some examples, the display 310 may be curved to transmit light from the display in the direction of the eyebox 304. A curvature of the display 310 may be spherical, cylindrical, or a combination of those depending at least in part on the head-mount display (HMD) device configuration, a shape and size of the compensation element 312, and/or a shape and size of the focus element 308. To allow the light from the environment 318 pass through to the focus element 308, the display 310 may be transparent. In other examples, the display 310 may be flexible and shaped according to the configuration of the remaining components.

The display 310 may be manufactured using absorptive or emissive technologies. Absorptive technologies may include liquid crystal displays (LCDs), while emissive technologies may include light-emitting diode (LED) based displays. LED-based displays may include organic LED (OLED) or inorganic LED-based displays. Further examples of transparent displays may include, but are not limited to, projection displays, where images or videos are projected onto a transparent material; passive transparent displays, which utilize a projector as the external light source to project images or videos onto a transparent medium embedded with resonant nanoparticles that may selectively scatter the projected light; and electroluminescent displays, which may include a luminescent phosphorous layer sandwiched between two transparent electrodes layers. Other examples may include MicroLED displays or any transparent pixelated emitters.

In some examples, the optical assembly combining the focus element 308, the display 310 (transparent and curved), and the compensation element 312 may allow the light from the environment 318 and the light from the display 316 to be focused on the eyebox 304 while reducing aberrations such as chromatic aberration that may be created by thinner, lighter optical elements in a light-weight head-mount display (HMD) device.

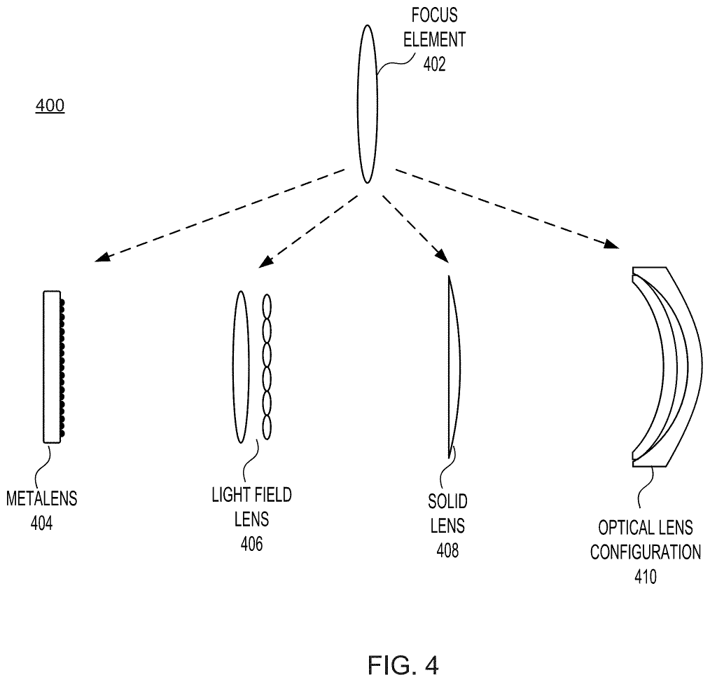

FIG. 4 illustrates a number of implementations of the optical element, according to an example. Diagram 400 shows four example implementations of focus element 402. The focus element 402 may be implemented as a metalens 404, a light field lens 406, a solid lens 408, or as an optical lens configuration 410 also referred to as hollow singlet optical lens configuration.

To reduce weight and bulkiness, optical lenses may be designed in flat form such as diffractive lenses. For example, in a diffractive lens that mimics a plano-convex refractive lens, the convex surface may be flattened by breaking it down into radial zones. However, such diffractive lenses may have strong chromatic aberration, that is, the focal point of the lens may shift linearly with an inverse of the wavelength at wavelengths other than the main wavelength of the lens.

In some examples, metalenses are optical components made using flat lens techniques and use metasurfaces to focus light. Metalenses, which may be used together with or in place of diffractive lenses, may be made from metamaterial—referring to subwavelength-level artificially engineered 3D material with effective optical parameters. In a metalens, the phase may be induced via a response of nanostructures formed on a surface of a substrate material. Metalenses may also manipulate a polarization of light, while diffractive surfaces cannot. Thus, the metalens 404 may be used as the focus element 402 providing reduction of bulkiness and weight while also reducing chromatic aberration through the polarization manipulation during focusing of the light from the environment 318 and the light from the display 316 on the eyebox 304.

In some examples, light field lens 406 may be an optical lens or collection of optical elements used to capture information from the light field in a particular scene, including intensity, color, and direction of the light rays. Thus, a three-dimensional model of the scene may be constructed. The additional data captured by the light field lens, also referred to as the rich light field data, may include depth maps and/or different perspectives of the scene taken at a moment of capture. The light field lens 406 may be implemented as one or more microlens arrays. Having an array of hundreds of microlenses in front of a single digital sensor may allow for the light field information (rich light field data) to be captured producing an image that may be made up of any number of sub-images. The light field lens 406 may also include a liquid lens, a zoom focusing lens, a liquid crystal lens, etc.

In some examples, another alternative implementation for the focus element 402 may be a solid lens 408 also referred to herein as optical element or optical lens. In case of the solid lens 408, the chromatic aberration may be digitally corrected with pre-chromatic correction display (the display may be transparent pixelated OLED, LED, MicroLED, or other RGB emitters).

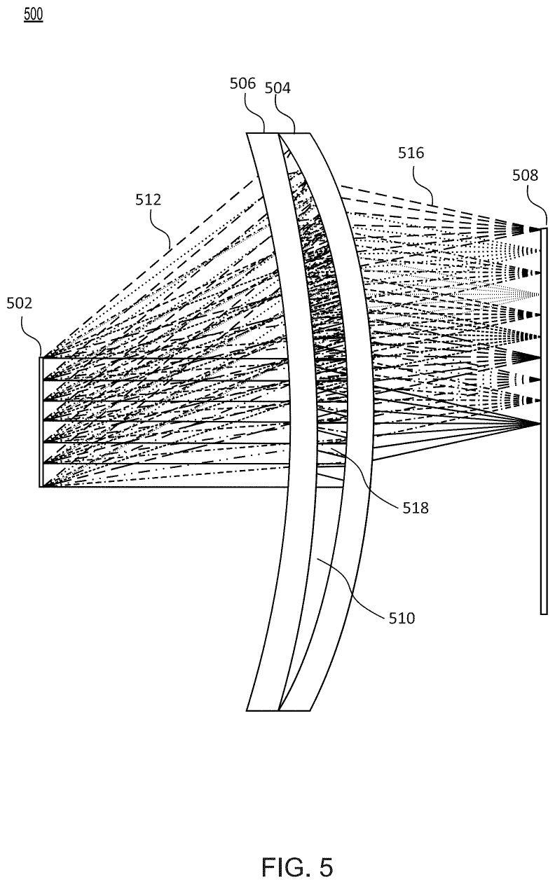

In some examples, an optical lens configuration 410 with two optical elements having a gap in between them may be used as the focus element 402. As discussed in more detail herein (FIGS. 5-9), surfaces of the individual elements may also be provided with any number of optical layers. These may include, but not limited to, a reflective polarizer layer, a quarter wave layer, a semi-transparent mirror, or other optical layer. These optical layers may be used by the optical lens configuration, for example, to help focus visual content on a display of the head-mount display (HMD) system to an eyebox.

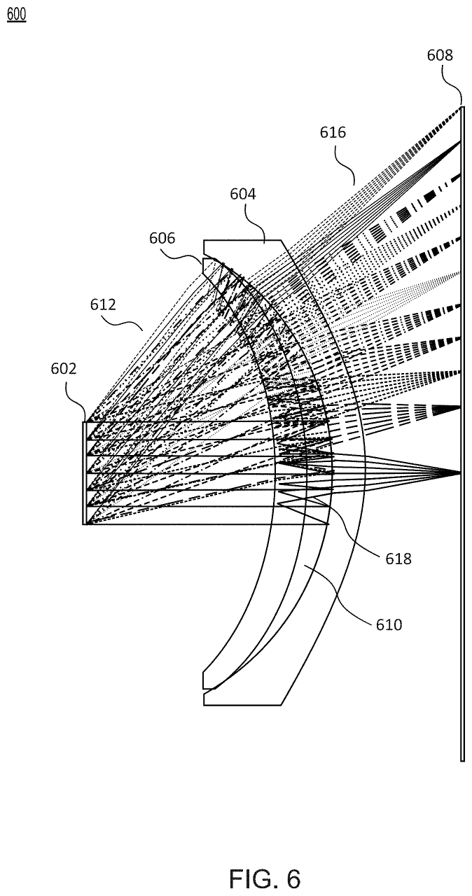

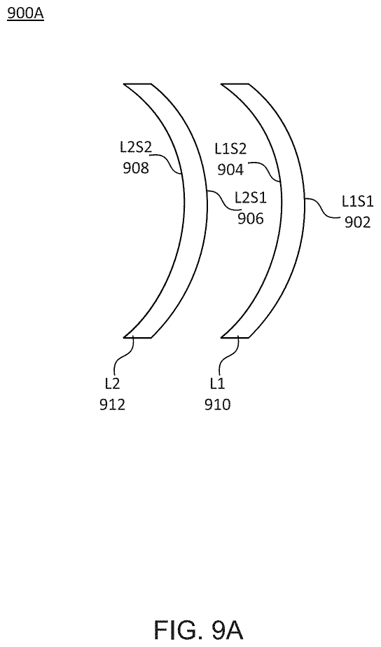

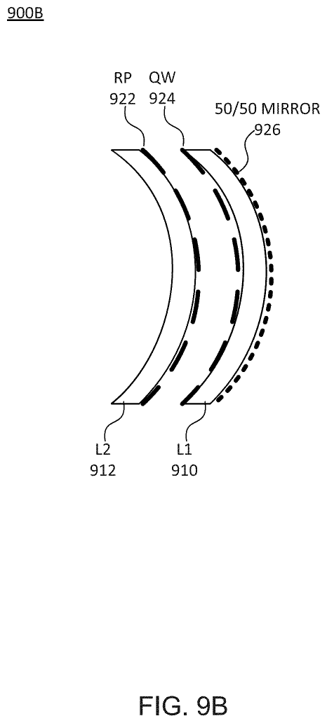

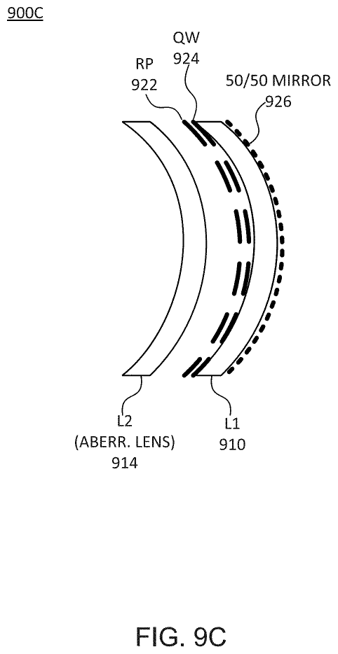

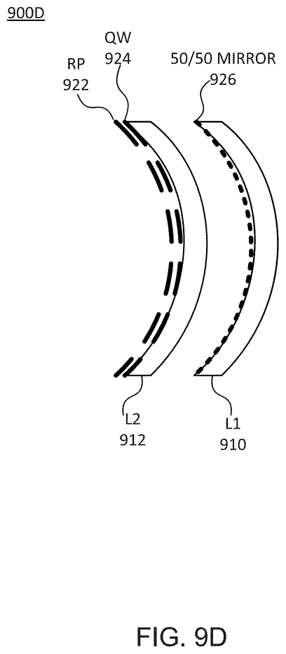

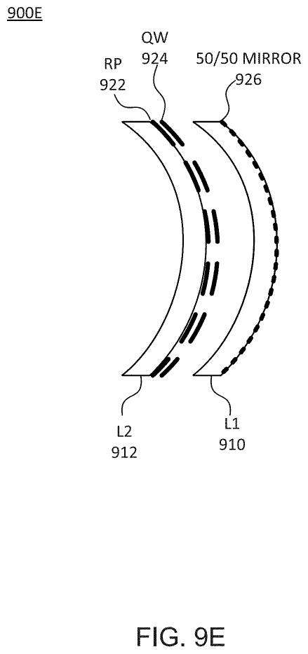

FIG. 5 illustrates focusing of visual content from a display to an eyebox through an optical lens configuration, where the display is smaller than the optical lens configuration, according to an example. Diagram 500 shows light rays 516 from display 508 arriving at a first surface of the optical lens configuration, which may include a first optical element 504 and a second optical element 506 with an air gap 510 between them. Light rays 518 in the air gap 510 are a mixture of refracted and reflected light rays with reflections being caused by a semi-transparent mirror applied to one of the optical element surfaces as discussed in conjunction with FIGS. 6 and 9A-9E. The optical lens configuration may allow the focused light rays 512 (displayed content) to be provided to an eyebox 502 allowing the user to view the entire content on the display 508, which is wider than the eyebox 502.

In some examples, first optical element 504 and second optical element 506 may be selected from a number of optical lens types such as convex, concave, plano-convex, plano-concave, positive meniscus, or negative meniscus. At least one of the first optical element 504 and second optical element 506 may also be uniform, that is, neither convex, nor concave. In some examples, selected surfaces of the first optical element 504 and second optical element 506 may be provided with a reflective polarizer layer, a quarter wave layer, and/or a semi-transparent mirror to provide polarization adjustment and reflection of the light rays for enhanced optical focus power while keeping the lenses thin (i.e., light-weight).

FIG. 6 illustrates focusing of visual content from a display to an eyebox through an optical lens configuration, where the display is larger than the optical lens configuration, according to an example. Diagram 600 shows light rays 616 from display 608 arriving at a first surface of the optical lens configuration, which may include a first optical element 604 and a second optical element 606 with an air gap 610 between them. Light rays 618 in the air gap 610 are a mixture of refracted and reflected light rays with reflections being caused by a semi-transparent mirror applied to one of the optical element surfaces as discussed in conjunction with FIGS. 6 and 9A-9E. The optical lens configuration may allow the focused light rays 612 (displayed content) to be provided to an eyebox 602 allowing the user to view the entire content on the display 608.

In some examples, as shown in diagram 600, the first optical element 604 may be a meniscus negative optical lens, that is, the optical lens may function as a concave optical lens, and the second optical element 606 may be a meniscus positive optical lens, that is, the optical lens may function as a convex optical lens. By selecting the shape and strength of the optical elements, a wider display area may be focused on the eyebox 602, as shown in diagram 600. As in FIG. 5, selected surfaces of the first optical element 604 and second optical element 606 may be provided with a reflective polarizer layer, a quarter wave layer, and/or a semi-transparent mirror to provide polarization adjustment and reflection of the light rays for enhanced optical focus power.

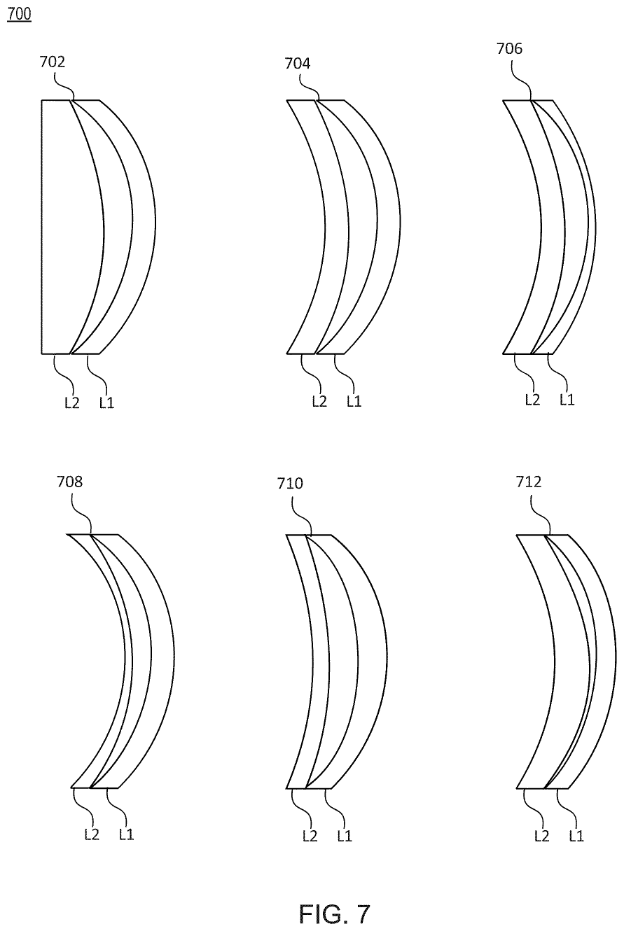

FIG. 7 illustrates a number of optical lens configuration configurations for the focus element, according to an example. Diagram 700 includes example optical lens configurations 702, 704, 706, 708, 710, and 712, where the first optical element is identified as L1 and the second optical element is identified as L2 in each configuration. In optical lens configuration 702, L1 may be a uniform optical lens and L2 may be a plano convex optical lens. In optical lens configuration 704, L1 and L2, both may be uniform optical lenses. In optical lens configuration 706, L1 may be a meniscus negative optical lens and L2 may be a uniform optical lens. In optical lens configuration 708, L1 may be a uniform optical lens and L2 may be a meniscus negative optical lens. In optical lens configuration 710, L1 may be a meniscus positive optical lens and L2 may be a uniform optical lens. In optical lens configuration 712, L1 may be a uniform optical lens and L2 may be a meniscus positive optical lens.

Optical focus power (also referred to as dioptric, refractive, or convergence power) is a degree to which an optical lens or similar optical system converges or diverges light. Optical focus power is equal to a reciprocal of the focal length of the optical lens or system. High optical focus power may correspond to short focal length. Converging optical lenses such as those typically used in a head-mount display (HMD) device to focus display content on an eyebox may have positive optical focus power. For two or more thin optical lenses close together, the optical focus power of the combined optical lenses may approximately equal to a sum of optical focus powers of each optical lens. Similarly, the optical focus power of a single optical lens (e.g., a meniscus positive optical lens) may be approximately equal to a sum of the optical focus powers of each surface.

In some examples, the additional surfaces of the individual optical lenses in the optical lens configuration may provide refractive surfaces for reduction of spherical aberration, coma, astigmatism, and/or field curvature. Thus, image precision on the eyebox may be improved by the optical lens configuration.

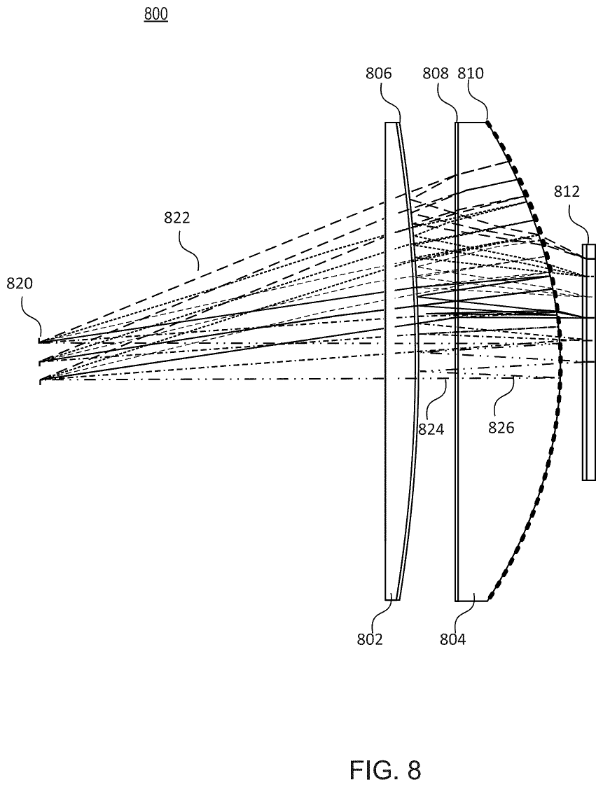

FIG. 8 illustrates details of an optical lens configuration for a focus element with a reflective polarizer layer, a quarter wave layer, and a semi-transparent mirror, according to an example. The example optical lens configuration in diagram 800 is shown with two optical elements separated for illustration of reflections and refractions. Diagram 800 includes display 812, first optical element 804, second optical element 802, and eyebox 820. A reflective polarizer layer 806 is shown on a first surface of the second optical element 802, a semi-transparent mirror 810 is shown on a first surface of the first optical element 804, and a quarter wave layer 808 is shown on a second surface of the first optical element 804. Light rays 826 passing through the first optical element 804, light rays 824 in the gap between the two optical elements, and light rays 822 arriving at the eyebox 820 are also shown in the diagram 800.

In some examples, the first surface (facing the first optical element 804) of the second optical element 802 may be provided with a reflective polarizer layer 806. A reflective polarizer may transmit light with a particular polarization and reflect the light with other polarizations. In an optical see-through augmented reality (AR) system, polarization management may be critical to improve an ambient contrast ratio and brightness of the display. Traditional polarizing beam splitters (PBSs) used for polarization management may provide remarkable performance, but they may be too bulky and heavy for head-mount display (HMD) devices, whereas compactness and light weight may be sought-after characteristics for head-mounted AR displays. In some examples, a thin reflective polarizer layer 806 may be laminated on the first surface of the second optical element 802 uniformly providing similar performance to the performance of the polarizing beam splitter (PBS). In a reflective polarizer, unpolarized ambient light partially may pass through while polarized display light (e.g., from display 812) may be reflected by the reflective polarizer. Thus, the head-mount augmented reality (AR) system may effectively combine images displayed by the display 812 with the outside world.

However, reflective polarizers—as do the polarizing beam splitters (PBSs)— may have a challenge. In practical implementations, only about half of the unpolarized ambient light may pass through while the other half is reflected back. The decreased transmittance may make it difficult for inconspicuous display systems where the display may need to disappear into the background. In some examples, a quarter wave layer 808 may be provided on a second surface of the first optical element 804 to remedy the transmittance shortcoming of the reflective polarizer layer 806. A quarter wave layer may alter a polarization state of a light wave travelling through it by converting linearly polarized light into circularly polarized light. If unpolarized ambient light is passed through the quarter wave layer 808, it may become linearly or circularly polarized. Thus, transmittance of the ambient light (environment) may be increased through the reflective polarizer layer 806.

Wave plates may be constructed using a birefringent material such as quartz, mica, or plastic, for which the index of refraction may be different for linearly polarized light along one or the other of two certain perpendicular crystal axes. The behavior of a wave plate may depend on a thickness of the crystal, a wavelength of light, and a variation of the index of refraction. Selecting these parameters, a controlled phase shift between two polarization components of a light wave may be introduced, thereby altering the light wave's polarization.

In some examples, a semi-transparent mirror 810 may be provided on a first surface of the first optical element 804. Also called a one-way mirror or a 50/50 mirror, semi-transparent mirrors are reciprocal mirrors that appear reflective on one side and transparent on the other side. While semi-transparent mirrors may be constructed through a number of techniques, one example technique may include coating or encasing glass or similar material with a thin and almost-transparent layer of metal such as aluminum. Reflection of light rays by the semi-transparent mirror 810 in a direction of the eyebox 820 may increase an amount of light focused by the optical lens configuration.

In some examples, light from the display may pass through the semi-transparent mirror 810 and become focused by the first optical element 804. As the light exits the first optical element 804, its polarization may be changed as it passes through the quarter wave layer 808. Passing through the gap between the optical elements, the light from the display may pass through the reflective polarizer layer 806 and be further focused by the second optical element 802 arriving at the eyebox 820. Unpolarized light from the environment (in an augmented reality (AR) application) may pass through the semi-transparent mirror 810 and be focused by the first optical element 804. The light from the environment may become at least partially polarized by the quarter wave layer 808 as it exits the first optical element 804. The partially polarized light from the environment may pass through the gap between the optical elements and at least partially pass through the reflective polarizer layer 806 into the second optical element 802, where it may be further focused on the eyebox 820. A portion of the light from the environment, which may be reflected by the reflective polarizer layer 806 may pass through the quarter wave layer 808, first optical element 804, and be reflected back by the semi-transparent mirror 810. As that reflected light becomes further polarized by the quarter wave layer 808, a larger portion may pass through the reflective polarizer layer 806 and arrive at the eyebox 820. Thus, a loss of light from the environment for the augmented reality (AR) application may be substantially reduced.

In some examples, an optical lens configuration may include an assembly of two optical elements attached together with an air gap in-between. Optical materials may be subject to chromatic dispersion, which may cause scattering of a signal at different wavelengths. An example optical lens configuration may utilize two complementary dispersing optical elements to compensate the chromatic dispersion and have a resulting optical lens configuration with similar focusing power over the entire wavelength range. Thus, an achromatic optical lens configuration may limit effects of chromatic and spherical aberration. In some examples, one of the optical elements may be a negative (concave) element with relatively high dispersion, and the other optical element may be a positive (convex) element with lower dispersion. Other configurations may also be implemented. While conventional doublet lens structures commonly utilize two lenses cemented together without a gap or a liquid (e.g., oil) filled gap, such implementations may fail to address the challenge of size and weight in a head-mount display (HMD) device. An example, optical lens configuration with the air gap between the two optical elements may allow thinner, lighter optical lenses to be used with lower overall weight and may also be easier to manufacture. For example, the optical lens configuration may be formed by affixing the two optical elements mechanically or chemically (e.g., gluing) along their peripheral edges. In some examples, an inert gas or similar may also be used to fill the gap instead of air.

In diagram 800, the first optical element 804 and the second optical element 802 are shown as plano-convex optical lenses, but implementations are not limited to this configuration. Other optical lens types may also be selected using the principles discussed herein. Furthermore, the reflective polarizer layer 806, the quarter wave layer 808, and the semi-transparent mirror 810 are shown on specific surfaces of the first optical element 804 and the second optical element 802. Examples are not limited to these configurations. As discussed in conjunction with FIGS. 9A-9E, the three light treatment layers may be provided in other configurations too.

FIGS. 9A-9E illustrate a number of configurations of reflective polarizer layer, quarter wave layer, and semi-transparent mirror in an optical lens configuration for the focus element, according to an example. Diagram 900A of FIG. 9A shows an example two-element configuration to serve as legend for the example configurations of light treatment layers in FIGS. 9B-9E. In diagram 900A, a first optical element (L1) 910 and a second optical element (L2) 912 are shown as uniform optical lenses for simplicity purposes. As discussed herein, both optical elements may include any optical lens type depending on the overall optical lens configuration construction. A first surface (facing a display) 902 of the first optical element (L1) 910 may be designated as L1S1. A second surface (facing toward an eyebox) 904 of the first optical element (L1) 910 may be designated as L1S2. A first surface (facing toward the display) 906 of the second optical element (L2) 912 may be designated as L2S1. A second surface (facing the eyebox) 908 of the second optical element (L2) 912 may be designated as L2S2.

Diagram 900B of FIG. 9B shows a first example configuration, where a reflective polarizer layer (RP) 922 may be provided on a first surface of the second optical element (L2S1), a quarter wave layer (QW) 924 may be provided on a second surface of the first optical element (L1S2), and a semi-transparent mirror (50/50 mirror) 926 may be provided on a first surface of the first optical element (L1S1).

Diagram 900C of FIG. 9C shows a second example configuration, where the quarter wave layer (QVV) 924 may be provided on the second surface of the first optical element (L2S1), the reflective polarizer layer (RP) 922 may be provided on the quarter wave layer (QVV) 924, and the semi-transparent mirror (50/50 mirror) 926 may be provided on the first surface of the first optical element (L1S1). In this configuration, the second optical element (L2) 914 may function as an aberration correction lens.

Diagram 900D of FIG. 9D shows a third example configuration, where the quarter wave layer (QVV) 924 may be provided on the second surface of the second optical element (L2S2), the reflective polarizer layer (RP) 922 may be provided on the quarter wave layer (QVV) 924, and the semi-transparent mirror (50/50 mirror) 926 may be provided on the second surface of the first optical element (L2S1).

Diagram 900E of FIG. 9E shows a fourth example configuration, where the reflective polarizer layer (RP) 922 may be provided on the first surface of the second optical element (L1S2), the quarter wave layer (QVV) 924 may be provided on the reflective polarizer layer (RP) 922, and the semi-transparent mirror (50/50 mirror) 926 may be provided on the first surface of the first optical element (L1S1).

As discussed in conjunction with FIG. 8, the shapes and types of the individual optical elements and placement of the light treatment layers may be selected in other configurations different from the ones shown in FIGS. 9B—9E using the principles described herein.

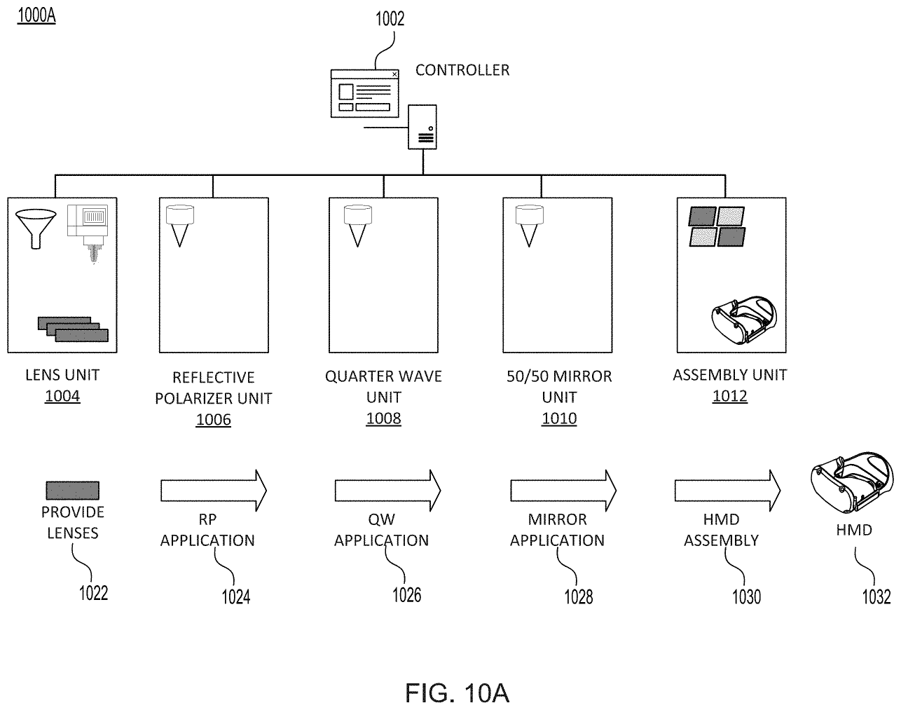

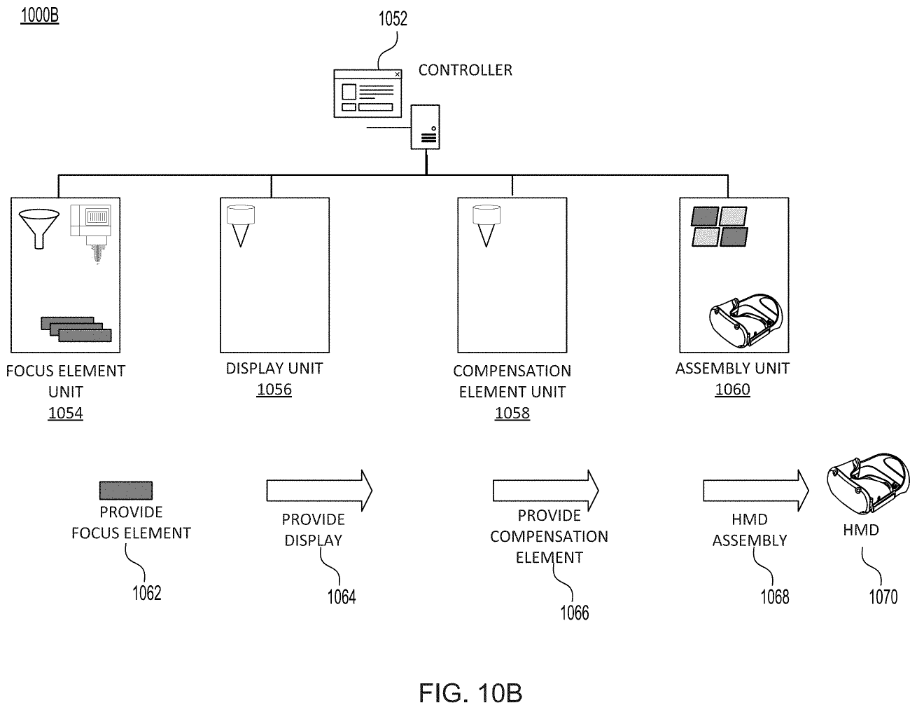

FIG. 10A illustrates an assembly system to provide a head-mount display (HMD) device with an optical lens configuration, according to an example. Diagram 1000A shows a controller 1002 managing operations of individual assembly units including a lens unit 1004, a reflective polarizer unit 1006, a quarter wave unit 1008, a semi-transparent (50/50) mirror unit 1010, and an assembly unit 1012. Individual optical elements (e.g., first optical element and second optical element) may be provided (1022) by the lens unit 1004 followed by application of the reflective polarizer layer (1024) by the reflective polarizer unit 1006 on one of the surfaces of one of the optical elements. A quarter wave layer may be applied to one of the surfaces of one of the optical elements or over the reflective polarizer layer by quarter wave unit 1008 followed by application of the semi-transparent mirror (1026) on one of the surfaces of one of the optical elements by the semi-transparent (50/50) mirror unit 1010. The treated lenses may be assembled (1030) together to form an optical lens configuration and then assembled together with the remaining components of the head-mount display (HMD) device 1032 by the assembly unit 1012.

In some examples, the lens unit 1004 may provide the optical elements (e.g., first optical element and second optical element) using any suitable optical material, but not limited to, glass, optical grade plastics such as poly-methyl-methacrylate (PMMA), cyclic-olefin-copolymer (COC), cyclo-olefin-polymer (COP), monomer plastic, polymer plastic, polycarbonate (PC), epoxy, polyester, optical nylon, etc. The optical elements may be provided using casting, injection molding, compression molding, machining, polishing, and/or similar methods or techniques.

In some examples, the reflective polarizer unit 1006 may provide the reflective polarizer layer on a surface of one of the optical elements using birefringent material such as calcite, linear polymer film (e.g., polyvinyl alcohol “PVA” based), a modified polycarbonate, or similar. The reflective polarizer layer may be provided using lamination, spraying, and/or similar methods or techniques.

In some examples, the quarter wave unit 1008 may provide the quarter wave layer on a surface of the optical elements (or on the reflective polarizer layer) using materials such as quartz (crystalline SiO2), mica, or modified polycarbonates. The quarter wave layer may be formed as a separate layer and laminated or otherwise affixed to the surface of the optical element or the reflective polarizer layer as a thickness of the quarter wave layer is a critical characteristic that may need to be adjusted with high precision.

In some examples, the semi-transparent (50/50) mirror unit 1010 may provide the semi-transparent mirror on a surface of one of the optical elements by applying a thin layer of metal (e.g., aluminum, silver, gold, or similar) onto a thin layer of glass or a transparent polymer material, and then laminating or similarly affixing the mirror to the optical element surface. In other examples, the mirror may be formed on the surface of the optical element layer by layer by using suitable application techniques such as injection, lamination, spraying, vapor deposition, etc.

As discussed herein, an optical lens configuration may include an assembly of two optical elements attached together with an air gap in-between. Contrary to conventional doublet lens structures, which commonly utilize two lenses cemented together without a gap or a liquid (e.g., oil) filled gap, an example, optical lens configuration may be assembled by affixing the two optical elements mechanically or chemically (e.g., gluing) along their peripheral edges. In some examples, an inert gas or similar may also be used to fill the gap instead of air.

FIG. 10B illustrates an assembly system to provide a head-mount display (HMD) device with an optical assembly including a focus element, a transparent display, and a compensation element, according to an example. Diagram 1000B shows a controller 1052 managing operations of individual assembly units including a focus element unit 1054, a display unit 1056, a compensation element unit 1058, and an assembly unit 1060. The focus element unit 1054 may provide (1062) any alternative implementation of the focus element 402 such as metalens 404, light field lens 406, solid lens 408, or optical configuration 410 (hollow singlet optical lens configuration). The display unit 1056 may provide (1064) a transparent and curved display 310, which may be shaped according to the configuration of the components. The compensation element unit 1058 may provide (1066) a compensation element 312 such as a free-form phase plate. The individual components of the optical assembly may be assembled (1068) along with other parts of a head-mount display (HMD) device 1070 by the assembly unit 1060.

The modules (stations) of example head-mount display (HMD) assembly systems to produce head-mount display (HMD) devices with optical lens configurations or with a focus element, a transparent display, and a compensation element as described herein are for illustration purposes and do not imply limitations on the assembly system. Some of the modules may be implemented as a single station performing any number of functions at any number of stages of assembly. An order of the modules (i.e., assembly steps) may be different than shown in the diagram. The assembly system may also be implemented using fewer or additional modules using the principles described herein.

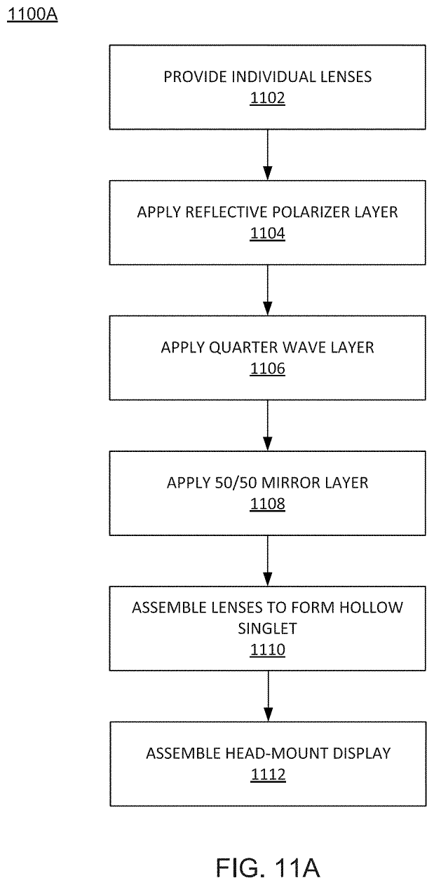

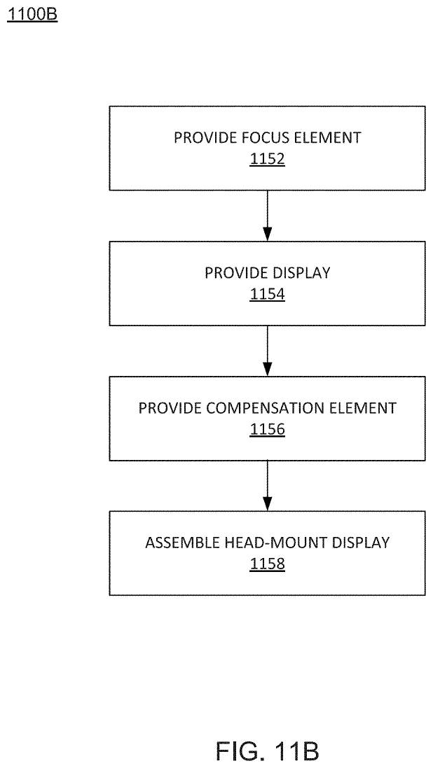

FIG. 11A illustrates a flowchart 1100A of a method to assemble a head-mount display (HMD) device with an optical lens configuration, according to an example. Each block shown in FIG. 11A may further represent one or more processes, methods, or subroutines, and one or more of the blocks may include machine-readable instructions stored on a non-transitory computer readable medium and executed by a processor or other type of processing circuit to perform one or more operations described herein.

At 1102, first optical element (L1) 804 and second optical element (L2) 802 may be provided using any suitable optical material, but not limited to, glass, optical grade plastics such as poly-methyl-methacrylate (PMMA), cyclic-olefin-copolymer (COC), cyclo-olefin-polymer (COP), monomer plastic, polymer plastic, polycarbonate (PC), epoxy, polyester, optical nylon, etc. The optical elements may be provided using casting, injection molding, compression molding, machining, polishing, and/or similar methods or techniques. At 1104, the reflective polarizer layer 806 may be provided on a surface of either the first optical element (L1) 804 or the second optical element (L2) 802 using lamination, spraying, and/or similar methods or techniques.

At 1106, the quarter wave layer 808 may be provided on one of the surfaces of either the first optical element (L1) 804 or the second optical element (L2) 802 or on the reflective polarizer layer 806. The quarter wave layer 808 may be formed as a separate layer and laminated or otherwise affixed to the surface of one of the optical elements or the reflective polarizer layer. At 1108, the semi-transparent mirror 810 may be provided on one of the surfaces of either the first optical element (L1) 804 or the second optical element (L2) 802 by applying a thin layer of metal (e.g., aluminum, silver, gold, or similar) onto a thin layer of glass or a transparent polymer material, and then laminating or similarly affixing the mirror to the optical element surface.

At 1110, the treated optical elements (with the reflective polarizer layer 806, the quarter wave layer 808, and the semi-transparent mirror 810) may be assembled together to form the optical lens configuration. The optical lens configuration may be assembled by affixing the two optical elements mechanically or chemically (e.g., gluing) along their edges. In some examples, an inert gas or similar may also be used to fill the gap instead of air. At 1112, the head-mount display (HMD) device 1032 may be assembled by combining any number of electronic, mechanical, and optical parts such as the optical lens configuration, body 102, head strap 110, and other components.

FIG. 11B illustrates a flowchart 1100B of a method to assemble a head-mount display (HMD) device with an optical assembly including a focus element, a transparent display, and a compensation element, according to an example. Each block shown in FIG. 11B may further represent one or more processes, methods, or subroutines, and one or more of the blocks may include machine-readable instructions stored on a non-transitory computer readable medium and executed by a processor or other type of processing circuit to perform one or more operations described herein

At 1152, alternative implementations of the focus element 402 such as metalens 404, light field lens 406, solid lens 408, or optical configuration 410 (hollow singlet optical lens configuration) may be provided by a focus element unit 1054. In some examples, the focus element may be formed by the focus element unit 1054 (e.g., affixing of two optical lens elements and application of reflective polarizer, quarter wave, and semi-transparent mirror layers in case of the optical configuration 410 alternative). In other examples, the focus element 402 may be formed elsewhere and provided for assembly with the other components by the focus element unit 1054.

At 1154, a transparent, curved display 310 may be provided by display unit 1056. A transparent display is an electronic display that may allow the user to see what is shown on the screen while still being able to see through the display. A curved display is a display technology that features three-dimensional (3D) screens instead of traditional two-dimensional (2D) screens. The display's shape and size may be selected to match the focus element and/or the compensation element. In some examples, the display may be a flexible display and formed to shape based on the other components. In other examples, the display may have a fixed shape and/or size, and the focus element and the compensation element may be selected in shape and size to match the display.

At 1156, a compensation element 312 may be provided by the compensation element unit 1058. The compensation element may be a free-form phase plate, for example, and used to adjust a phase of the light from the environment 318. At 1158, the individual components of the optical assembly, aligned around the primary axis 306, may be assembled along with other mechanical, optical, and electronic parts of the head-mounted display (HMD) device 1070.

According to some examples, an optical assembly may include a compensation element to modify a phase of a first light arriving from an environment outside a head-mounted display (HMD) device; a transparent display to present an image or a video and to pass through the phase-modified first light; and a focus element to focus the phase-modified first light and a second light from the transparent display on an eyebox, where the optical assembly is to reduce one or more aberrations in the first light or the second light.

According to some examples, the compensation element may include a free-form phase plate, a zoom focus lens, or a liquid lens. The compensation element may have a substantially similar optical focus power as that of the focus element, but with a reverse sign, or the compensation element may have a different focus power as that of the focus element to correct one or more of a myopia, a hyperopia, or an astigmatism. The compensation element may be fabricated through one or more of cylindrical coordinate machining, etching, photolithography, grinding, raster flycutting, or a holography technique. The focus element may include a metalens, a light field lens, a solid optical lens, or an optical configuration comprising two optical elements with an air gap between the two optical elements.

According to some examples, the light field lens may include a microlens array, a liquid lens, a zoom focusing lens, or a liquid crystal lens. The transparent display may have a curvature comprising a spherical curvature, a cylindrical curvature, or a combination thereof. A shape and a size of the transparent display may be selected based, at least in part, on one or more of a shape and a size of the compensation element or a shape and a size of the focus element. The transparent display, the compensation element, and the focus element may be aligned along a primary optical axis of the head-mounted display (HMD) device.

According to some examples, a head-mounted display (HMD) device may include a body comprising a transparent front side and an optical assembly within the body. The optical assembly may include a compensation element to modify a phase of a first light arriving from an environment outside the head-mounted display (HMD) device; a transparent display to present an image or a video and to pass through the phase-modified first light; and a focus element to focus the phase-modified first light and a second light from the transparent display on an eyebox, where the optical assembly is to reduce one or more aberrations in the first light or the second light.

According to some examples, the compensation element may include a free-form phase plate, a zoom focus lens, or a liquid lens. The focus element may include a metalens, a light field lens, a solid optical lens, or an optical configuration comprising two optical elements with an air gap between the two optical elements. The light field lens may include a microlens array, a liquid lens, a zoom focusing lens, or a liquid crystal lens. The compensation element may have a substantially similar optical focus power as that of the focus element, but with a reverse sign, or the compensation element may have a different focus power as that of the focus element to correct one or more of a myopia, a hyperopia, or an astigmatism. The transparent display, the compensation element, and the focus element may be aligned along a primary optical axis of the head-mounted display (HMD) device.

According to some examples, a method for a head-mounted display (HMD) device may include modifying, at a compensation element, a phase of a first light arriving at the compensation element from an environment outside the head-mounted display (HMD) device; providing an image or a video, by a transparent display, while allowing the phase-modified first light to pass through the transparent display; and focusing, at a focus element, the phase-modified first light and a second light from the transparent display on an eyebox, where the compensation element and the focus element are to reduce one or more aberrations in the first light or the second light.

According to some examples, the method may further include focusing, by the compensation element, an optical power from the focus element; or correcting, by the compensation element, one or more of a myopia, a hyperopia, or an astigmatism. The compensation element may include a free-form phase plate, a zoom focus lens, or a liquid lens. The focus element may include a metalens, a light field lens, a solid optical lens, or an optical configuration comprising two optical elements with an air gap between the two optical elements. The light field lens may include a microlens array, a liquid lens, a zoom focusing lens, or a liquid crystal lens.

According to some examples, a system and/or a method of making an optical assembly as described herein may also be provided. According to other examples, a non-transitory computer-readable storage medium may have an executable stored thereon, which when executed may instruct a processor to perform the methods of making an optical assembly and/or a head-mounted display (HMD) device as described herein.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to focusing of displayed digital content, such as videos or interactive media, it should be appreciated that the methods and systems as described herein may be used for other types of content or scenarios as well.

1. An optical assembly, comprising:
a compensation element to modify a phase of a first light arriving from an environment outside a head-mounted display (HMD) device;
a transparent display to present an image or a video and to pass through the phase-modified first light; and
a focus element to focus the phase-modified first light and a second light from the transparent display on an eyebox, wherein the optical assembly is to reduce one or more aberrations in the first light or the second light.

2. The optical assembly of claim 1, wherein the compensation element comprises a free-form phase plate, a zoom focus lens, or a liquid lens.

3. The optical assembly of claim 2, wherein the compensation element is further to focus an optical power from the focus element.

4. The optical assembly of claim 2, wherein the compensation element is further to correct one or more of a myopia, a hyperopia, or an astigmatism.

5. The optical assembly of claim 1, wherein the compensation element is fabricated through one or more of cylindrical coordinate machining, etching, photolithography, grinding, raster flycutting, or a holography technique.

6. The optical assembly of claim 1, wherein the focus element comprises one of:
a metalens;
a light field lens;
a solid optical lens; or
an optical configuration comprising two optical elements with an air gap between the two optical elements.

7. The optical assembly of claim 6, wherein the light field lens comprises a microlens array, a liquid lens, a zoom focusing lens, or a liquid crystal lens.

8. The optical assembly of claim 1, wherein the transparent display has a curvature comprising a spherical curvature, a cylindrical curvature, or a is combination thereof.

9. The optical assembly of claim 1, wherein a shape and a size of the transparent display is selected based, at least in part, on one or more of a shape and a size of the compensation element or a shape and a size of the focus element.

10. The optical assembly of claim 1, wherein the transparent display, the compensation element, and the focus element are aligned along a primary optical axis of the head-mounted display (HMD) device.

11. A head-mounted display (HMD) device, comprising:
a body comprising a transparent front side; and
an optical assembly within the body, the optical assembly comprising:
a compensation element to modify a phase of a first light arriving from an environment outside the head-mounted display (HMD) device;
a transparent display to present an image or a video and to pass through the phase-modified first light; and
a focus element to focus the phase-modified first light and a second light from the transparent display on an eyebox, wherein the optical assembly is to reduce one or more aberrations in the first light or the second light.

12. The head-mounted display (HMD) device of claim 11, wherein:
the compensation element comprises a free-form phase plate, a zoom focus lens, or a liquid lens; and
the focus element comprises a metalens, a light field lens, a solid optical lens, or an optical configuration comprising two optical elements with an air gap between the two optical elements.

13. The head-mounted display (HMD) device of claim 12, wherein the light field lens comprises a microlens array, a liquid lens, a zoom focusing lens, or a liquid crystal lens.

14. The head-mounted display (HMD) device of claim 11, wherein the compensation element is further to:
focus an optical power from the focus element; or
correct one or more of a myopia, a hyperopia, or an astigmatism.

15. The head-mounted display (HMD) device of claim 11, wherein the transparent display, the compensation element, and the focus element are aligned along a primary optical axis of the head-mounted display (HMD) device.

16. A method for a head-mounted display (HMD) device, comprising:
modifying, at a compensation element, a phase of a first light arriving at the compensation element from an environment outside the head-mounted display (HMD) device;
providing an image or a video, by a transparent display, while allowing the phase-modified first light to pass through the transparent display; and
focusing, at a focus element, the phase-modified first light and a second light from the transparent display on an eyebox, wherein the compensation element and the focus element are to reduce one or more aberrations in the first light or the second light.

17. The method of claim 16, further comprising:
focusing, by the compensation element, an optical power from the focus element; or
correcting, by the compensation element, one or more of a myopia, a hyperopia, or an astigmatism.

18. The method of claim 16, wherein the compensation element comprises a free-form phase plate, a zoom focus lens, or a liquid lens.

19. The method of claim 16, wherein the focus element comprises a metalens, a light field lens, a solid optical lens, or an optical configuration comprising two optical elements with an air gap between the two optical elements.

20. The method of claim 19, wherein the light field lens comprises a microlens array, a liquid lens, a zoom focusing lens, or a liquid crystal lens.
